(19) United States
(12) Patent Application Publication
(10) Pub. No.: US 2026/0036237 A1
(43) Pub. Date: Feb. 5, 2026

(54) METHOD FOR CONNECTING TWO PLASTIC PIPES TOGETHER, AS WELL AS AN INDUCTION CONNECTING SLEEVE FOR USE IN THE METHOD

(71) Applicant: MERISA INVESTMENTS BV, CM Helmond (NL)

(72) Inventors: Erik BIJLOO, CM Helmond (NL); Kees DONK, VAN DER, CM Helmond (NL)

(21) Appl. No.: 19/099,789

(22) PCT Filed: Jul. 31, 2023
(86) PCT No.: PCT/NL2023/050407

§ 371 Date: Jan. 30, 2025

(30) Foreign Application Priority Data
Jul. 31, 2022 (NL) 2032647

(51) Int. Cl. F16L 47/02; B29C 65/00; B29C 65/36

(52) U.S. Cl. CPC F16L 47/02; B29C 65/36; B29C 66/1312; B29C 66/30321; B29C 66/5221; B29C 66/861

(57) ABSTRACT

To connect two plastic pipes 3 together, an induction connection sleeve 1 is used, which is provided with annular recesses 5 into which the pipes 3 with the ends 3A are pushed. Subsequently, induction heating elements 9 present in the induction connecting sleeve are heated with induction hand pliers 21 and the induction connecting sleeve is pressed against the end 3A of one of the tubes 3. The induction connection sleeve fuses to the tube. Because the induction hand pliers 21 are provided with ribs 27, grooves 19 are pressed into the pipe wall 3B in order to check whether sufficient heating and pressing has taken place over the entire circumference to obtain a gastight connection.

### TECHNICAL FIELD OF THE INVENTION

The invention relates to a method for connecting two plastic pipes together by means of an induction connection sleeve provided with a cylindrical part over which the pipes with their ends can slide, wherein at least one induction heating element is present in the wall of the induction connection sleeve, in which method first at least one of the two tubes to be connected to each other is inserted with one of its ends over and/or into the induction connection sleeve, then electric currents are induced into the induction heating element by means of a primary induction coil, causing heat development in the induction heating element and locally softening or melting of the induction connection sleeve, and simultaneously causing pressure on the outside of the tube at the location of the induction connection sleeve and/or on the outside of the induction connection sleeve to melt the tube and the induction connection sleeve together or to fuse the tube and the induction connection sleeve.

### BACKGROUND OF THE INVENTION

A method according to the preamble of claim 1 is known from EP2172328A1. With the known method, it is only after connecting the two pipes that it can be checked whether the connection is good and no leakage occurs, for example by introducing a gas or liquid under pressure into the pipes and checking whether it is not leaking out anywhere.

### SUMMARY OF THE INVENTION

It is an object of the present invention to provide a method in which it can be checked immediately after attaching an induction connecting sleeve to an end of a tube whether this attachment has been carried out properly. To this end, the method according to the invention is characterized in that the pressure on the tube and/or on the induction connection sleeve is exerted by an induction hand pliers provided with two arcuate pressing jaws, which are placed around the induction connection sleeve and/or around the pipe at the location of the induction connection sleeve and which are provided with ribs with which at least one circumferential groove in the pipe and/or in the induction connection sleeve is formed, which circumferential groove serves to check whether the induction hand pliers has sufficiently heated the entire circumference.

If the groove is interrupted or shallower in one or more places, this is an indication that no sufficient heating has taken place over the entire circumference or that during heating the tube and the induction connection sleeve have not been pressed against each other with sufficient force. The induction hand pliers can then be placed around the pipe again and heated and pressed until the groove is present over the entire circumference of the pipe and/or the induction connection sleeve and has preferably the same depth over the entire circumference.

The above is then repeated with the other of the two tubes to be connected together.

An embodiment of the method according to the invention, which achieves a better attachment of the pipes to each other, is characterized in that an induction connection sleeve is used which is provided with a flange in the middle, against which the pipes with their ends can be pushed, wherein the induction heating element is present in the cylindrical part of the induction connection sleeve and in the flange of the induction connection sleeve, in which method, at least one of the two pipes to be connected to each other is first inserted with one end over the cylindrical part of the induction connection sleeve up to the flange, after which the induction hand pliers with the pressing jaws are placed around the pipe at the location of the induction connection sleeve and the at least one circumferential groove is formed in the pipe.

A further embodiment of the method according to the invention, which achieves better attachment of the tubes to each other and which allows good control of the correctness of the connection, is characterized in that the induction connection sleeve used is further provided with an annular, outer boundary wall which is attached to the flange, the cylindrical part of the induction connection sleeve and the outer boundary wall are concentric and an annular recess is formed between the outer boundary wall and the cylindrical part of the induction connection sleeve on either side of the flange, into which recesses the tubes with their ends can be pushed up to the flange, whereby the induction heating element is also present in the outer boundary wall, in which method, at least one of the two tubes to be connected together is first inserted with one end into one of the annular recesses, after which the induction hand pliers with the pressing jaws are placed around the outer boundary wall of the induction connection sleeve and the circumferential groove is formed in the outer boundary wall of the induction connection sleeve.

Yet another embodiment of the method according to the invention, which allows good control of the correctness of the connection, is characterized in that the cylindrical part of the induction connection sleeve extends partly beyond the outer boundary wall, wherein the induction hand pliers also is placed around a wall part of the tube within which the part of the cylindrical part of the induction connection sleeve extending beyond the outer boundary wall extends, and wherein next to the circumferential groove in the outer boundary wall of the induction connection sleeve a further circumferential groove is formed in the wall of the tube.

The invention also relates to an induction connecting sleeve for attaching two tubes to each other, which induction connection sleeve is provided with annular recesses in axial surfaces facing away from each other, into which recesses the tubes with their ends can be pushed, which annular recesses are each bounded by a cylindrical part of the induction connection sleeve and an annular outer boundary wall opposite it, wherein an induction heating element is present in this cylindrical part and in the outer boundary wall.

An induction connection sleeve according to the preamble of claim 4 is known from EP2172328A1. During use, tubes with their ends are inserted into the annular recesses of the induction connection sleeve. Hereby there are gaps between the boundary walls of the recesses and the pipe walls. During the heating of the induction connection sleeve, the boundary walls of the recesses must be melted against the pipe walls over the entire circumference or fused to the pipe walls over the entire circumference to ensure that no leakage can occur. Only after connecting both pipes one can check whether the connection is good and no leakage is occurring by introducing a gas or liquid under pressure into the pipes.

A further object of the invention is to provide an induction connection sleeve with which it can be checked immediately after mounting on an end of a pipe whether this mounting has been carried out properly. To this end, the induction connection sleeve according to the invention is characterized in that at least one control hole is present in the outer boundary wall to check whether the tubes to be joined together are inserted far enough into the annular recesses.

An embodiment of the induction connection sleeve is characterized in that the cylindrical part of the induction connection sleeve extends partly beyond the outer boundary wall. This also allows parts of the tube next to the recesses to be heated. By pressing a circumferential groove into these parts of the pipe during heating, the condition of this groove can be used to check whether the connection has been made over the entire circumference. If the groove is interrupted or locally shallower, this is an indication that the connection may not be satisfactory. In addition, the induction connection sleeve is attached to the pipes over an extra length, which further reduces the chance of an incorrect connection.

The invention further relates to an induction connecting sleeve for attaching two tubes to each other, which induction connecting sleeve is provided in the middle with at least one flange against which the ends of the pipes can be pushed, whereby in the cylindrical part of the induction connecting sleeve and in the flange of the induction connection sleeve, the induction heating element is present.

In order to be able to check whether this attachment has been carried out properly when using such an induction connection sleeve, immediately after mounting on an end of a pipe, this induction connection sleeve is characterized in that the induction connection sleeve is provided with recesses in both axial surfaces of the flange, which recesses extend to the outer circumference of the flange. If sufficient heating has taken place for a good connection, the recesses will be filled with molten material from the induction connection tube during heating. If this is not the case, this may indicate a bad connection. The induction hand pliers can be pressed around the tube or tubes for a certain period of time, after which it is checked whether the material of the induction connection sleeve has melted at the location of the recesses, or the induction hand pliers is pressed around the tube or tubes until it is observed that the material of the induction connection sleeve has melted, which is an indication that a good connection has been made.

A further embodiment of the induction connection sleeve according to the invention is characterized in that it comprises at least one support sleeve that is present against the inside of the cylindrical part of the induction connection sleeve. This support sleeve prevents the induction connection sleeve from pressing inwards when heated and pressed from the outside, which would prevent a good connection between the induction connection sleeve and the tube.

Yet another embodiment of the induction connection sleeve according to the invention is characterized in that the induction heating element is provided with outwardly protruding teeth, so that after the tube has been pushed over the induction connection sleeve, the tube can no longer be withdrawn. This prevents the tube from shifting during heating/fusion.

### BRIEF DESCRIPTION OF THE DRAWINGS

The invention will be explained in more detail below on the basis of exemplary embodiments of the induction connection sleeve and method according to the invention shown in the drawings. In the drawings:

FIG. 1 shows a first embodiment of the induction connection sleeve according to the invention in perspective;

FIG. 2 shows the induction connection bus shown in FIG. 1 in an exploded view;

FIG. 3 shows the induction connection sleeve shown in FIG. 1 and the end of a tube to which the induction connection sleeve is attached;

FIG. 4 shows the induction connection sleeve shown in FIG. 1 on the end of the pipe with induction hand pliers for attaching the induction connection sleeve to the pipe;

FIG. 5 shows the induction connection sleeve shown in FIG. 1 at the end of the tube with the induction hand pliers present around the induction connection sleeve and around the tube;

FIG. 6 shows a cross-section of the situation shown in FIG. 5;

FIG. 7 shows the induction connection sleeve shown in FIG. 1 attached to the end of the tube with the induction hand pliers removed from the induction connection sleeve;

FIG. 8 shows an enlarged detail of the situation shown in FIG. 7;

FIG. 9 shows a second embodiment of the induction connection sleeve according to the invention in perspective;

FIG. 10 shows the induction connection sleeve shown in FIG. 9 in cross-section;

FIG. 11 shows the induction connection sleeve with transparent outer wall shown in FIG. 9;

FIG. 12 shows one of the induction heating elements of the induction connection sleeve shown in FIG. 9;

FIG. 13 shows two in-line tubes containing the induction connection sleeve shown in FIG. 9 before they are melted together; and

FIG. 14 shows two tubes perpendicular to each other containing a perpendicular induction connection sleeve before they are melted together.

### DETAILED DESCRIPTION OF THE DRAWINGS

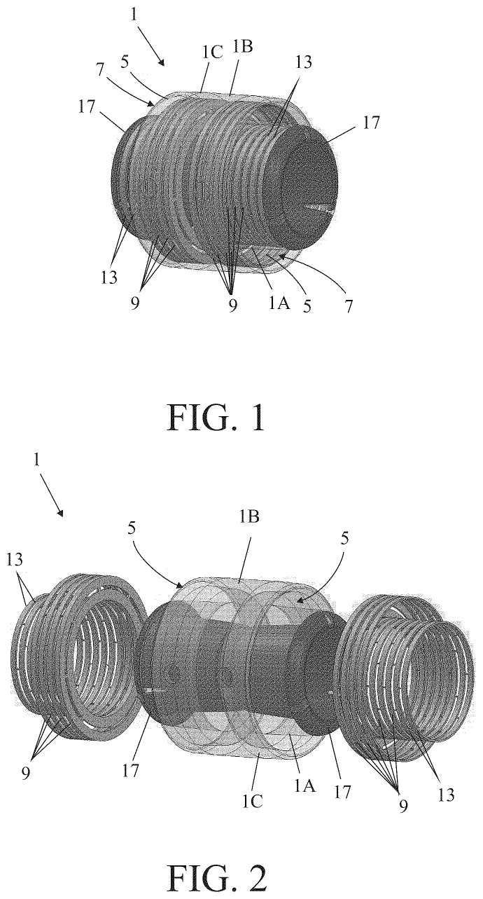

FIGS. 1 and 2 show a first embodiment of the induction connection sleeve 1 according to the invention. The induction connection sleeve 1 is provided with two annular recesses 5 in axial surfaces 7 facing away from each other of a flange 1B located in the center of the induction connection sleeve 1. Each annular recess 5 is bounded by the flange 1B, a cylindrical part 1A and an outer boundary wall 1C. The cylindrical part 1A and the outer boundary wall 1C are concentric and spaced apart. Annular induction heating elements 9 are present in the cylindrical part 1A and in the outer boundary wall 1C. A part 1D of the cylindrical part 1A extends beyond the outer boundary wall 1C and in this part 1D further induction heating elements 13 are located.

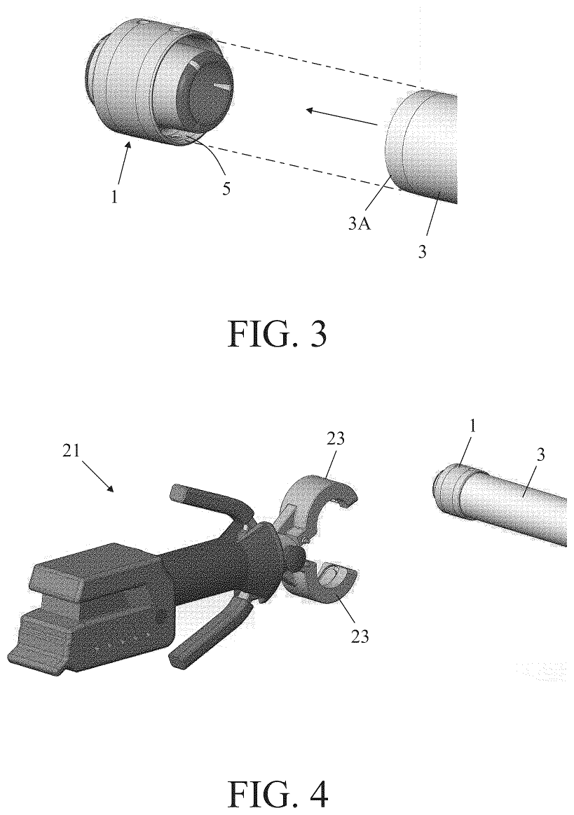

When connecting two tubes together, they are attached one by one in the induction connection sleeve 1. The first tube 3 is inserted with an end 3A into one of the annular recesses 5, see FIG. 3. The induction connection sleeve 1 is then attached with induction hand pliers 21 to the end of tube 3. FIG. 4 shows the induction hand pliers 21 with open pressing jaws 23.

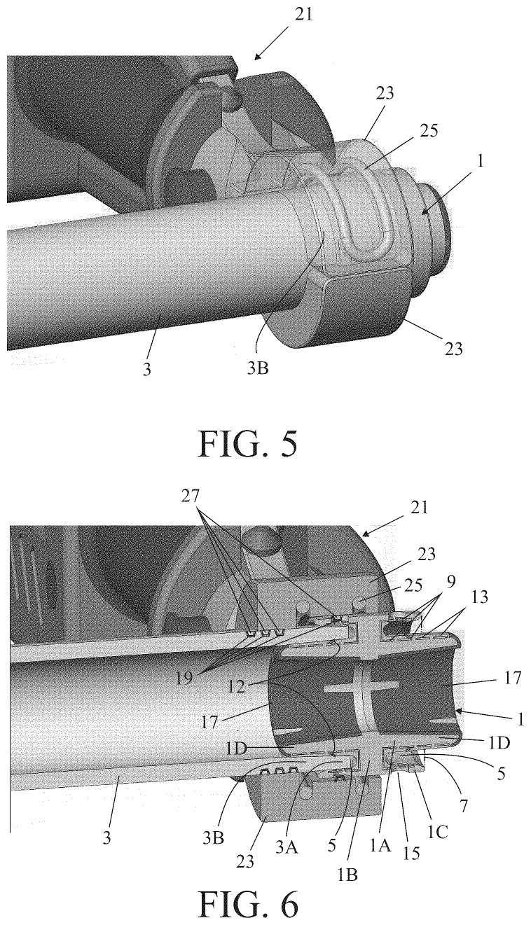

The semicircular pressing jaws 23 are provided with induction coils 25 and press against one half of the induction connection sleeve 1 and against a wall part 3B of the tube 3, see FIG. 5 in which the upper pressing jaw 23 is shown transparently.

In FIG. 6, the tube 3 and the induction connecting sleeve 1 pushed onto it and the pressing jaws 23 of the induction hand pliers 21 are shown in longitudinal section. A control hole 15 is present in each outer boundary wall 1C of the annular recesses 5 to check whether the tube 3 has been inserted far enough into the annular recess 5. One of the induction heating elements 9, preferably an element located near the end 3A of tube 3, has an inward toothing 12 so that after insertion of the tube 3 it can no longer be withdrawn gripping ring. This prevents the tube from shifting during heating/fusion. The induction connection sleeve 1 further has two support sleeves 17 that rest against the inside of the cylindrical part 1A and support this part.

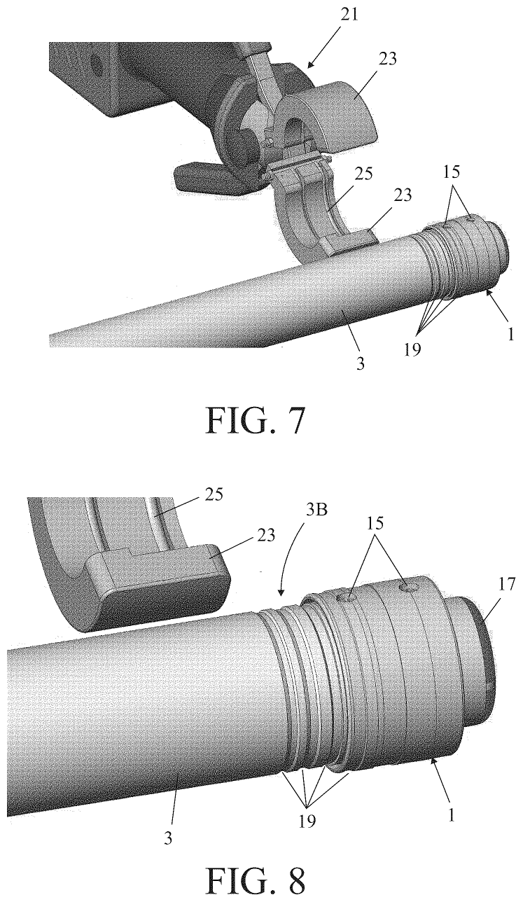

The pressing jaws 23 are provided with ribs 27 on the inside, with which circumferential grooves 19 are formed in the outer boundary wall 1C of the induction connection sleeve 1 and in the wall part 3B of the tube 3. These circumferential grooves 19 are used to check whether the induction pliers 21 have heated the induction connection sleeve 1 sufficiently over the entire circumference to create a gastight connection. In FIG. 7 the induction connection sleeve 1 and the tube 3 provided with grooves 19 are shown in perspective and, for clarity, FIG. 8 shows an enlarged detail of FIG. 7 in which the grooves 19 are even more clearly visible.

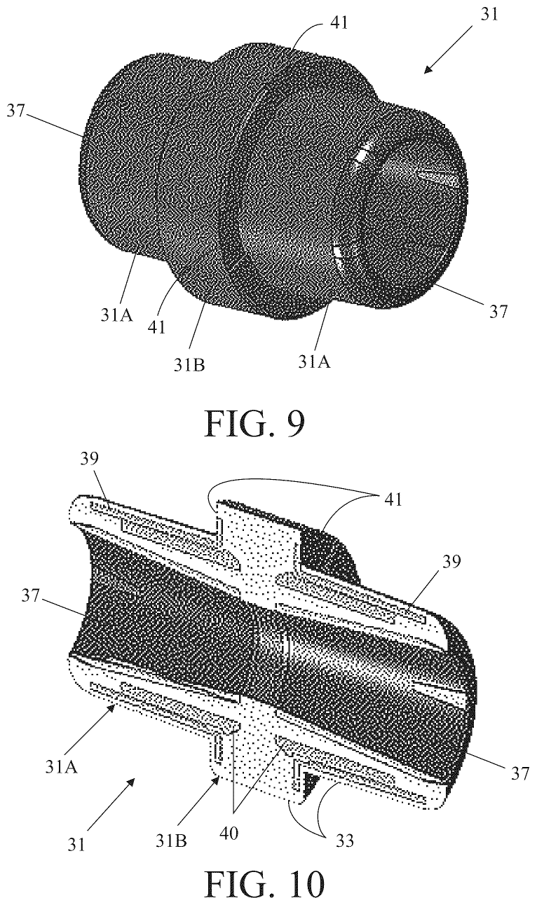

FIGS. 9 and 10 show a second embodiment of the induction connection sleeve 31 according to the invention in perspective and in longitudinal section, respectively. The induction connection sleeve 31 is provided with a cylindrical part 31A and is provided with a flange 31B in the middle. When connecting two pipes, they are slid over the cylindrical part up to the flange. Two induction heating elements 39 are present in the cylindrical part 31A and in the flange 31B of the induction connection sleeve 31. Furthermore, two additional induction heating elements 40 are present which are in contact with the induction heating elements 39 to create additional induction currents. Two support elements 37 are present against the inside of the cylindrical part 31A of the induction connection sleeve 31 to prevent the wall of the induction connection sleeve 31 from being pressed inward during heating.

In the axial surfaces of the flange 31B, distributed over the circumference in the outer casing 33 a number of recesses 41 are present which extend to the induction heating element 39. These recesses serve as an additional check whether the connection has been made properly. After the pipes have been pushed against the flange, these recesses 41 are visible in the flange. After heating, molten material has flowed from the flange into the recesses 41 and the recesses have been filled. If the recesses are properly filled, this is an indication that the induction connection sleeve 31 has been heated sufficiently to establish a good connection.

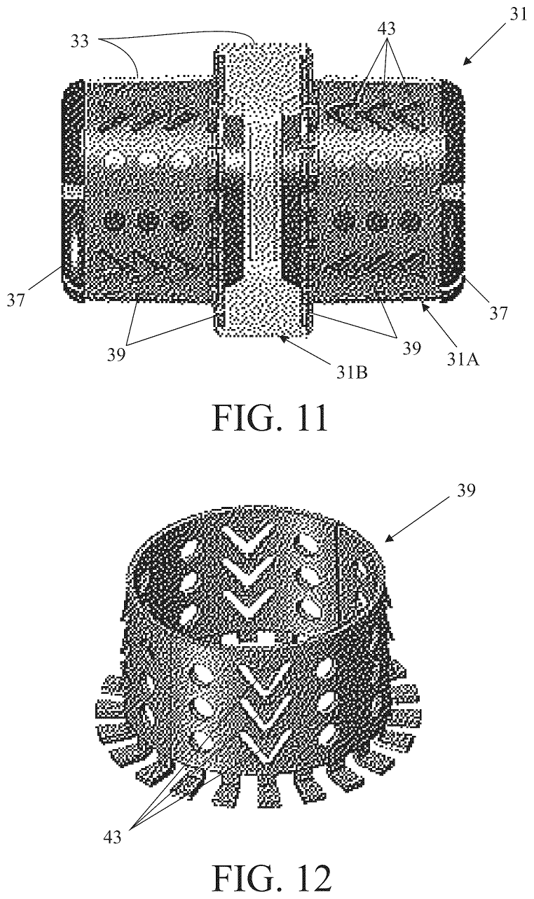

FIG. 11 shows the induction connection sleeve 31 with transparent jacket 33 and in FIG. 12 one of the induction heating elements 39 of the induction connection sleeve is shown separately. The induction heating element 39 is provided with outwardly protruding teeth 43 that function as barbs, so that after inserting a tube over the induction connecting sleeve 31, the tube can no longer be withdrawn.

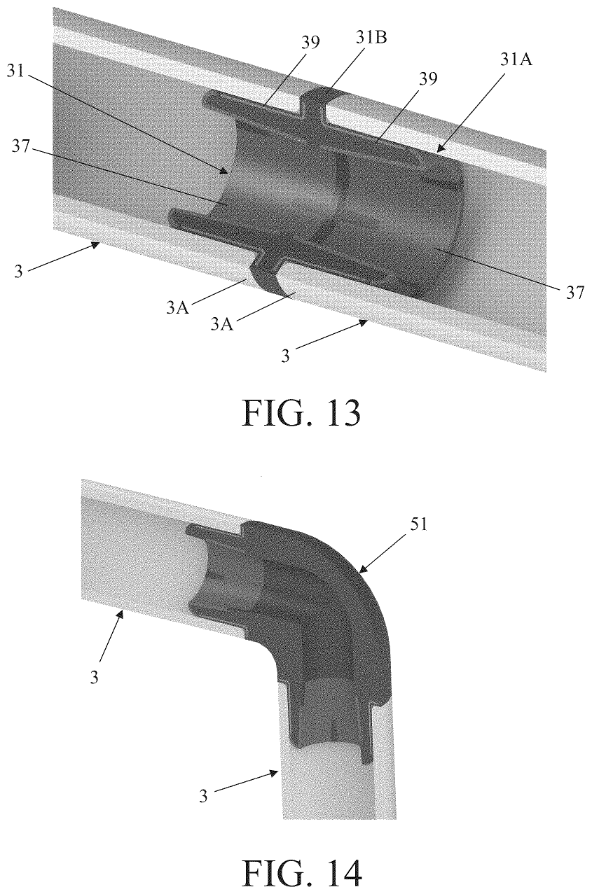

FIG. 13 shows two in-line tubes 3 containing the induction connection sleeve 31 before they are melted together. When attaching the tubes 3, they are each pushed with one end 3A against the flange 31B as visible in the figure. After this, induction hand pliers are placed around both ends 3A or successively around each of the ends to fuse the tubes to the induction connecting sleeve 31.

The induction connection sleeve can also have a different shape than the shapes described above. FIG. 14 shows a connection between two tubes 3 at right angles to each other by means of a perpendicular induction connection sleeve 51. The flange has the shape of a bend.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Method for connecting two plastic pipes (3) together by means of an induction connecting sleeve (1; 31) provided with a cylindrical part (1A; 31A) over which the pipes (3) with their ends (3A) can slide, wherein at least one induction heating element (9; 39) is present in the wall of the induction connecting sleeve (1; 31), in which method first at least one of the two tubes (3) to be connected to each other is inserted with one of its ends (3 A) over and/or into the induction connecting sleeve (1; 31), then electric currents are induced into the induction heating element (9; 39) by means of a primary induction coil (25), causing heat development in the induction heating element (9; 39) and locally softening or melting of the induction connecting sleeve (1; 31), and simultaneously causing pressure on the outside of the tube (3) at the location of the induction connecting sleeve (1) and/or on the outside of the induction connecting sleeve (1) to melt the tube (3) and the induction connecting sleeve (1; 31) together or to fuse the tube (3) and the induction connecting sleeve (1; 31), characterized in that the pressure on the tube (3) and/or on the induction connecting sleeve (1) is exerted by an induction hand pliers (21) provided with two arcuate pressing jaws (23), which are placed around the induction connecting sleeve (1) and/or around the pipe (3) at the location of the induction connecting sleeve (1; 31) and which are provided with ribs (27) with which at least one circumferential groove (19) in the pipe (3) and/or in the induction connecting sleeve (1) is formed, which circumferential groove (19) serves to check whether the induction hand pliers (21) has sufficiently heated the entire circumference.

2. Method according to claim 1, characterized in that an induction connecting sleeve (1; 31) is used which is provided with a flange (IB, 31B) in the middle, against which the pipes (3) with their ends (3A) can be pushed, wherein the induction heating element (9; 39) is present in the cylindrical part (1A; 31 A) of the induction connecting sleeve (1; 31) and in the flange (IB; 31B) of the induction connecting sleeve (1; 31), characterized in that in the method, at least one of the two pipes (3) to be connected to each other is first inserted with one end (3A) over the cylindrical part (1A; 31A) of the induction connecting sleeve (1; 31) up to the flange (IB; 3 IB), after which the induction hand pliers (21) with the pressing jaws (23) are placed around the pipe (3) at the location of the induction connecting sleeve (1; 31) and the at least one circumferential groove (19) is formed in the pipe (3).

3. Method according to claim 2, characterized in that the induction connecting sleeve (1) used is further provided with an annular, outer boundary wall (1C) which is attached to the flange (IB), the cylindrical part (1A) of the induction connecting sleeve (1) and the outer boundary wall (1C) are concentric and an annular recess (5) is formed between the outer boundary wall (1C) and the cylindrical part (1A) of the induction connecting sleeve (1) on either side of the flange (IB), into which recesses (5) the tubes (3) with their ends (3A) can be pushed up to the flange (IB), whereby the induction heating element (9) is also present in the outer boundary wall (1C), characterized in that in the method, at least one of the two tubes (3) to be connected together is first inserted with one end (3A) into one of the annular recesses (5), after which the induction hand pliers (21) with the pressing jaws (23) are placed around the outer boundary wall (1C) of the induction connecting sleeve (1) and the circumferential groove (19) is formed in the outer boundary wall (1C) of the induction connecting sleeve (1).

4. Method according to claim 3, characterized in that the cylindrical part (1A) of the induction connecting sleeve (1) extends partly (ID) beyond the outer boundary wall (1C), wherein the induction hand pliers (21) also is placed around a wall part (3B) of the tube (3) within which the part (ID) of the cylindrical part (1A) of the induction connecting sleeve (1) extending beyond the outer boundary wall (1C) extends, and wherein next to the circumferential groove (19) in the outer boundary wall (1C) of the induction connecting sleeve (1) a further circumferential groove (19) is formed in the wall of the tube (3).

5. Induction connecting sleeve (1) for use in the method according to claim 3 for attaching two tubes (3) to each other, which induction connecting sleeve (1) is provided with annular recesses (5) in axial surfaces (7) facing away from each other, into which recesses (5) the tubes (3) with their ends (3A) can be pushed, which annular recesses (5) are each bounded by a cylindrical part (1A) of the induction connecting sleeve (1) and an annular outer boundary wall (1C) opposite it, wherein an induction heating element (9) is present in this cylindrical part (1A) and in the outer boundary wall (1C), characterized in that at least one control hole (15) is present in the outer boundary wall (1C) to check whether the tubes (3) to be joined together are inserted far enough into the annular recesses (5).

6. Induction connecting sleeve (1) according to claim 5, characterized in that the cylindrical part (1A) of the induction connecting sleeve (1) extends partly (ID) beyond the outer boundary wall (1C).

7. Induction connecting sleeve (31) for use in the method according to claim 2 for attaching two pipes (3) to each other, which induction connecting sleeve (31) is provided in the middle with at least one flange (35) against which the pipes (3) can be pushed with the ends (3A), whereby the induction heating element (39) is present in the cylindrical part (31 A) of the induction connecting sleeve (31) and in the flange (3 IB) of the induction connecting sleeve (31), characterized in that the induction connecting sleeve (1) is provided with recesses (41) in both axial surfaces of the flange (3 IB), which recesses extend to the outer periphery of the flange (3 IB).

8. Induction connecting sleeve (1; 31) according to claim 5, characterized in that it comprises at least one support sleeve (17; 37) present against the inside of the cylindrical part (1A; 31A) of the induction connecting sleeve (1; 31).

9. Induction connecting sleeve (1; 31) according to claim 5, characterized in that the induction heating element (9, 13; 39) is provided with outwardly protruding teeth (12; 43) as a result of which the tube (3), after being pushed over the induction connection tube (1; 31) the tube (3), can no longer be withdrawn.
